(19) United States
(12) Patent Application Publication
(10) Pub. No.: US 2019/0261136 A1
(43) Pub. Date: Aug. 22, 2019

(54) Tracking Area Update Procedure For Intersystem Change In Mobile Communications

(71) Applicant: MediaTek Singapore Pte. Ltd., Singapore (SG)

(72) Inventors: Marko Niemi, Oulu (FI); Jarkko Eskelinen, Oulu (FI); Matti Moisanen, Oulu (FI); Jaakko Sitomaniemi, Oulu (FI)

(21) Appl. No.: 16/282,295

(22) Filed: Feb. 22, 2019

Related U.S. Application Data
(60) Provisional application No. 62/633,683, filed on Feb. 22, 2018.

(51) Int. Cl. H04W 4/029; H04W 8/08; H04W 60/06; H04W 88/02

(52) U.S. Cl. CPC H04W 4/029; H04W 88/023; H04W 60/06; H04W 8/08

(57) ABSTRACT

Various examples pertaining to an improved TAU procedure for intersystem change in mobile communications are described. A user equipment (UE) establishes a wireless communication connection with a first wireless network of a first type of wireless communication system. The UE then performs an intersystem change from being connecting to the first wireless network to being connected to a second wireless network of a second type of wireless communication system different from the first type. In performing the intersystem change, the UE constructs a tracking area update (TAU) request message and transmits the TAU request message to the second wireless network. The TAU request message identifies the UE.

### CROSS REFERENCE TO RELATED PATENT APPLICATION(S)

The present disclosure is part of a non-provisional application claiming the priority benefit of U.S. Patent Application No. 62/633,683, filed on 22 Feb. 2018, the content of which is herein incorporated by reference in its entirety.

### TECHNICAL FIELD

The present disclosure is generally related to mobile communications and, more particularly, to an improved tracking area update (TAU) procedure for intersystem change in mobile communications.

### BACKGROUND

Unless otherwise indicated herein, approaches described in this section are not prior art to the claims listed below and are not admitted as prior art by inclusion in this section.

The current 3^{rd}-Generation Partnership Project (3GPP) specification for 5^{th}-Generation (5G)/New Radio (NR) mobile communications requires that, in intersystem change from S1 mode to N1 mode, a registration request message sent by a user equipment (UE) to a network is to contain a complete TAU request message that is integrity protected. However, it is not defined in the 3GPP specification what should be the content of such “complete TAU request” message. Additionally, it is not yet specified how the UE, or its Evolved Packet System (EPS) Mobility Management (EMM) layer, should construct the “complete TAU request” message for mobility change to a 5^{th}-Generation System (5GS). This is a new feature for the EMM layer of the UE as TAU request is an EPS-specific message and, until now, TAU request is triggered only for intersystem change between EPS and Evolved Universal Terrestrial Radio Access Network (E-UTRAN) (e.g., tracking area update/change). Moreover, while it is specified that the Mobility Management Entity (MME) layer is to send an appropriate cause value to an access and mobility management function (AMF) in case the integrity check fails, it is not specified how the AMF and the UE are to behave in case of failure of integrity check.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

In one aspect, a method may involve a processor of a UE establishing a wireless communication connection with a first wireless network of a first type of wireless communication system. The method may also involve the processor performing an intersystem change from being connecting to the first wireless network to being connected to a second wireless network of a second type of wireless communication system different from the first type. In performing the intersystem change, the method may involve the processor constructing a TAU request message and transmitting the TAU request message to the second wireless network. The TAU request message may identify the UE.

In one aspect, an apparatus may include a transceiver capable of wireless communications. The apparatus may also include a processor coupled to the transceiver. The processor may be capable of establishing, via the transceiver, a wireless communication connection with a first wireless network of a first type of wireless communication system. The processor may be also capable of performing, via the transceiver, an intersystem change from being connecting to the first wireless network to being connected to a second wireless network of a second type of wireless communication system different from the first type. In performing the intersystem change, the processor may be capable of constructing a TAU request message and transmitting, via the transceiver, the TAU request message to the second wireless network. The TAU request message may identify the UE.

It is noteworthy that, although description provided herein may be in the context of certain radio access technologies, networks and network topologies such as 5G/NR, the proposed concepts, schemes and any variation(s)/derivative(s) thereof may be implemented in, for and by other types of radio access technologies, networks and network topologies such as, for example and without limitation, Universal Terrestrial Radio Access Network (UTRAN), Global System for Mobile communications (GSM), General Packet Radio Service (GPRS)/Enhanced Data rates for Global Evolution (EDGE) Radio Access Network (GERAN), Long-Term Evolution (LTE), LTE-Advanced, LTE-Advanced Pro, Internet-of-Things (IoT) and Narrow Band Internet of Things (NB-IoT). Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram of an example scenario in accordance with an implementation of the present disclosure.

FIG. 2 is a block diagram of an example communication system in accordance with an implementation of the present disclosure.

FIG. 3 is a flowchart of an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to an improved TAU procedure for intersystem change in mobile communications. According to the present disclosure, a number of possible schemes and solutions may be implemented separately or jointly. That is, although these possible solutions may be described below separately, two or more of these possible solutions may be implemented in one combination or another. It is noteworthy that, although description provided herein may be in the context of intersystem change between 5GS and EPS, the proposed schemes and solutions also apply to intersystem changes between 5GS and UTRAN, E-UTRAN or GERAN.

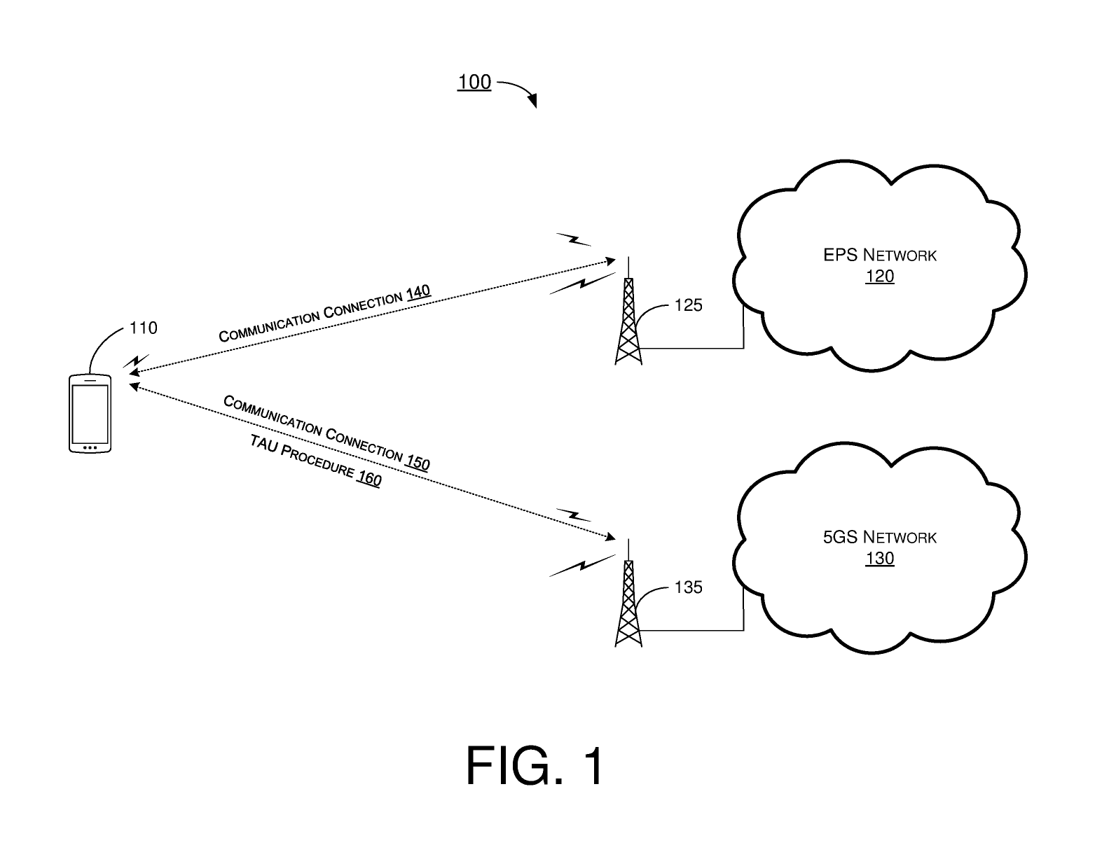

FIG. 1 illustrates an example scenario 100 in accordance with an implementation of the present disclosure. Referring to FIG. 1, scenario 100 involves a UE 110, a first wireless network 120 (e.g., an Evolved Packet Core (EPC) of an EPS network) and a second wireless network 130 (e.g., a 5GS network). At first, UE 110 may establish a wireless communication connection 140 with a first network node 125 of first wireless network 120. Later, UE 110 may perform an improved TAU procedure 160 for intersystem change from being connecting to first wireless network 120 to being connected to second wireless network 130 (e.g., by establishing a wireless communication connection 150 with a second network node 135 of second wireless network 130).

Under a proposed scheme in accordance with the present disclosure, in performing the intersystem change, UE 110 may construct a TAU request message and transmit the TAU request message to second network node 135 of second wireless network 130. Under the proposed scheme, the TAU request message may contain minimum content as the main purpose of the TAU request message is to identify UE 110 at the network (e.g., AMF and MME) and enhance security. Optimally, the TAU request message may contain certain mandatory information elements such as, for example and without limitation, a protocol discriminator, a security header type, a TAU request message identity, an EPS update type, a non-access stratum (NAS) key set identifier, and an old globally unique temporary identifier (GUTI).

Under a proposed scheme in accordance with the present disclosure, specific TAU request message for N1 mode (5G mobility management (5GMM) protocol) may have a new EPS update type such as, for example and without limitation, “TA updating for intersystem change from S1 mode to N1 mode.” This is because existing types, including “TA updating”, “periodic updating” and “combined TA/LA updating with IMSI attach”, are not suitable for this special TAU request for intersystem change to another system (mobility out of EPS). Under the proposed scheme, while encoding the TAU request message for the 5GS, UE 110 may encode the TAU request message using EMM protocol. That is, UE 110 may encode the TAU request message containing an EPS update type indicating TAU for intersystem change from S1 mode to N1 mode. Moreover, UE 110 may encode the TAU request message using the EMM protocol while remaining in an EMM-registered state. UE 110 may also consider that a tracking area updating procedure is not initiated and, accordingly, remain in the EMM-registered state after transmitting the TAU request message to the second network node 135. That is, UE 110 may refrain from entering into an EMM-tracking-area-updating-initiated state as a UE would normally do during TAU request initiation.

Under a proposed scheme in accordance with the present disclosure, UE 110 may transmit a registration request message to second network node 135 of second wireless network 130. Additionally, UE 110 may increment an uplink NAS count associated with an EPS security context by 1. This is because the uplink NAS count in EPS needs to be incremented by 1. In practice, both 5GS NAS count and EPS NAS counts may be incremented by 1, as described below. Firstly, the 5GMM NAS count may be incremented by 1 due to the registration request message having being sent to AMF. Secondly, the EPS NAS count may be incremented by 1 due to the TAU request message having been sent to 5GMM for piggy-backing the message in the registration request message in order to transmit the TAU request via AMF to MME.

Under a proposed scheme in accordance with the present disclosure, in an event that integrity check of the TAU request message fails in the MME, the MME may indicate the failure of integrity check to AMF. Furthermore, the AMF may send either a registration reject message or a deregistration request message to UE 110. The registration reject message may contain a cause value (e.g., cause #9) to indicate “UE identity cannot be derived” to request UE 110 to re-register in 5GS (in N1 mode). In this example, accordingly, UE 110 may perform cause #9 specific procedure(s) such as, for example and without limitation, entering into at least one of an EMM-deregistered state and a 5GMM-deregistered state. On the other hand, the deregistration request message may request UE 110 to re-register in 5GS (in N1 mode).

Alternatively, under the proposed scheme, in an event that integrity check of the TAU request message fails in the MME while integrity check of the registration request message is successful in the AMF, the AMF may send a registration accept message to UE 110 with a new cause value (or an indication) to inform UE 110 about the integrity check failure with the MME. Upon receipt of such indication, UE 110 may consider 5GMM registration successful and the EMM as deregistered. It is noteworthy that the new cause value or indication (from MME to AMF to UE 110) for this specific issue may also be used in other use cases. For example, this cause value or indication may be used when the EPS network (MME) has lost the UE context (e.g., due to MME reset) while UE 110 is still successfully registered in 5GS.

### Illustrative Implementations

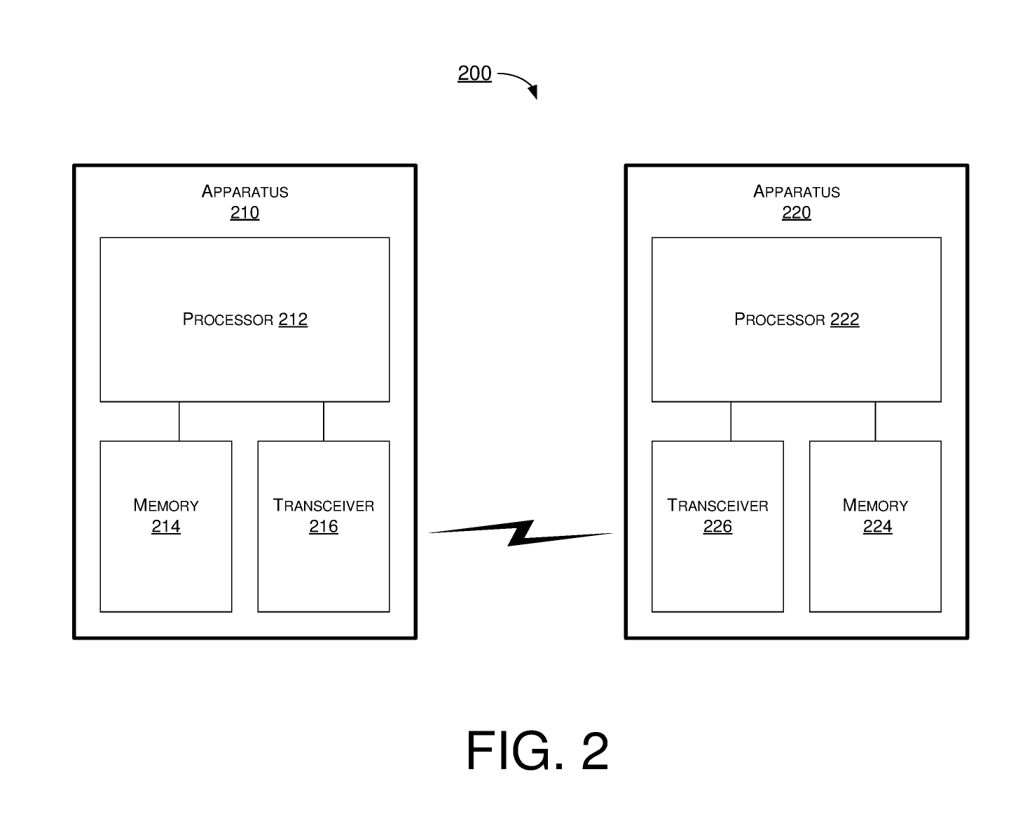

FIG. 2 illustrates an example system 200 having at least an example apparatus 210 and an example apparatus 220 in accordance with an implementation of the present disclosure. Each of apparatus 210 and apparatus 220 may perform various functions to implement schemes, techniques, processes and methods described herein pertaining to an improved TAU procedure for intersystem change in mobile communications, including the various schemes described above with respect to various proposed designs, concepts, schemes, systems and methods described above, including scenario 100, as well as process 300 described below.

Each of apparatus 210 and apparatus 220 may be a part of an electronic apparatus, which may be a network apparatus or a UE (e.g., UE 110), such as a portable or mobile apparatus, a wearable apparatus, a wireless communication apparatus or a computing apparatus. For instance, each of apparatus 210 and apparatus 220 may be implemented in a smartphone, a smart watch, a personal digital assistant, a digital camera, or a computing equipment such as a tablet computer, a laptop computer or a notebook computer. Each of apparatus 210 and apparatus 220 may also be a part of a machine type apparatus, which may be an IoT apparatus such as an immobile or a stationary apparatus, a home apparatus, a wire communication apparatus or a computing apparatus. For instance, each of apparatus 210 and apparatus 220 may be implemented in a smart thermostat, a smart fridge, a smart door lock, a wireless speaker or a home control center. When implemented in or as a network apparatus, apparatus 210 and/or apparatus 220 may be implemented in an eNodeB in an LTE, LTE-Advanced or LTE-Advanced Pro network or in a gNB or TRP in a 5G network, an NR network or an IoT network.

In some implementations, each of apparatus 210 and apparatus 220 may be implemented in the form of one or more integrated-circuit (IC) chips such as, for example and without limitation, one or more single-core processors, one or more multi-core processors, or one or more complex-instruction-set-computing (CISC) processors. In the various schemes described above, each of apparatus 210 and apparatus 220 may be implemented in or as a network apparatus or a UE. Each of apparatus 210 and apparatus 220 may include at least some of those components shown in FIG. 2 such as a processor 212 and a processor 222, respectively, for example. Each of apparatus 210 and apparatus 220 may further include one or more other components not pertinent to the proposed scheme of the present disclosure (e.g., internal power supply, display device and/or user interface device), and, thus, such component(s) of apparatus 210 and apparatus 220 are neither shown in FIG. 2 nor described below in the interest of simplicity and brevity.

In one aspect, each of processor 212 and processor 222 may be implemented in the form of one or more single-core processors, one or more multi-core processors, or one or more CISC processors. That is, even though a singular term “a processor” is used herein to refer to processor 212 and processor 222, each of processor 212 and processor 222 may include multiple processors in some implementations and a single processor in other implementations in accordance with the present disclosure. In another aspect, each of processor 212 and processor 222 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 212 and processor 222 is a special-purpose machine specifically designed, arranged and configured to perform specific tasks including those pertaining to an improved TAU procedure for intersystem change in mobile communications in accordance with various implementations of the present disclosure.

In some implementations, apparatus 210 may also include a transceiver 216 coupled to processor 212. Transceiver 216 may be capable of wirelessly transmitting and receiving data. In some implementations, transceiver 216 may be capable of wirelessly communicating with different types of wireless networks of different radio access technologies (RATs). In some implementations, transceiver 216 may be equipped with a plurality of antenna ports (not shown) such as, for example, four antenna ports. That is, transceiver 216 may be equipped with multiple transmit antennas and multiple receive antennas for multiple-input multiple-output (MIMO) wireless communications. In some implementations, apparatus 220 may also include a transceiver 226 coupled to processor 222. Transceiver 226 may include a transceiver capable of wirelessly transmitting and receiving data. In some implementations, transceiver 226 may be capable of wirelessly communicating with different types of UEs/wireless networks of different RATs. In some implementations, transceiver 226 may be equipped with a plurality of antenna ports (not shown) such as, for example, four antenna ports. That is, transceiver 226 may be equipped with multiple transmit antennas and multiple receive antennas for MIMO wireless communications.

In some implementations, apparatus 210 may further include a memory 214 coupled to processor 212 and capable of being accessed by processor 212 and storing data therein. In some implementations, apparatus 220 may further include a memory 224 coupled to processor 222 and capable of being accessed by processor 222 and storing data therein. Each of memory 214 and memory 224 may include a type of random-access memory (RAM) such as dynamic RAM (DRAM), static RAM (SRAM), thyristor RAM (T-RAM) and/or zero-capacitor RAM (Z-RAM). Alternatively, or additionally, each of memory 214 and memory 224 may include a type of read-only memory (ROM) such as mask ROM, programmable ROM (PROM), erasable programmable ROM (EPROM) and/or electrically erasable programmable ROM (EEPROM). Alternatively, or additionally, each of memory 214 and memory 224 may include a type of non-volatile random-access memory (NVRAM) such as flash memory, solid-state memory, ferroelectric RAM (FeRAM), magnetoresistive RAM (MRAM) and/or phase-change memory.

Each of apparatus 210 and apparatus 220 may be a communication entity capable of communicating with each other using various proposed schemes in accordance with the present disclosure. For illustrative purposes and without limitation, a description of capabilities of apparatus 210, as a UE, and apparatus 220, as a base station of a serving cell of a wireless network (e.g., 5G/NR mobile network), is provided below. It is noteworthy that, although the example implementations described below are provided in the context of a UE, the same may be implemented in and performed by a base station. Thus, although the following description of example implementations pertains to apparatus 210 as a UE (e.g., UE 110), the same is also applicable to apparatus 220 as a network node or base station such as a gNB, TRP or eNodeB (e.g., network node 135).

Under various proposed schemes in accordance with the present disclosure, processor 212 of apparatus 210 may be capable of performing a number of operations, including: (1) establishing, via transceiver 216, a wireless communication connection with a first wireless network of a first type of wireless communication system; and (2) performing, via transceiver 216, an intersystem change from being connecting to the first wireless network to being connected to a network node (e.g., apparatus 220) of a second wireless network of a second type of wireless communication system different from the first type. In performing the intersystem change, processor 212 may construct a TAU request message, with the TAU request message identifying apparatus 210. Additionally, processor 212 may transmit, via transceiver 216, the TAU request message to the second wireless network.

In some implementations, the first type of wireless communication system may include an EPS communication system, and the second type of wireless communication system may include a 5GS communication system.

In some implementations, the TAU request message may include a plurality of information elements such as, for example and without limitation, a protocol discriminator, a security header type, a TAU request message identity, an EPS update type, a NAS key set identifier, and an old GUTI.

In some implementations, in constructing the TAU request message, processor 212 may encode the TAU request message using an EMM protocol.

In some implementations, in encoding the TAU request message using the EMM protocol, processor 212 may encode the TAU request message containing an EPS update type indicating TAU for intersystem change from S1 mode to N1 mode.

In some implementations, in encoding the TAU request message using the EMM, processor 212 may encode the TAU request message using an EMM protocol while in an EMM-registered state. Additionally, processor 212 may consider that a tracking area updating procedure is not initiated and remain in the EMM-registered state after transmitting the TAU request message to the second wireless network.

In some implementations, in performing the intersystem change, processor 212 may perform additional operations. For instance, processor 212 may transmit, via transceiver 216, a registration request message to the second wireless network. Moreover, processor 212 may increment an uplink NAS count associated with an EPS security context by 1.

In some implementations, in performing the intersystem change, processor 212 may also receive, via transceiver 216, a registration reject message that requests the UE to re-register in the second type of wireless communication system and to perform a specific procedure. In receiving the registration reject message, processor 212 may receive the registration reject message responsive to failure of an integrity check of the TAU request message in a Mobility Management Entity (MME). In some implementations, the registration reject message may contain a cause value indicating that an identity of the UE cannot be derived, and the specific procedure may involve entering into at least one of an EMM-deregistered state and a 5GMM-deregistered state.

Alternatively, in performing the intersystem change, processor 212 may also receive, via transceiver 216, a deregistration request message that requests the UE to re-register in the second type of wireless communication system. In receiving the deregistration request message, processor 212 may receive the deregistration request message responsive to failure of an integrity check of the TAU request message in an MME.

Alternatively, in performing the intersystem change, processor 212 may also receive, via transceiver 216, a registration accept message with an indication of failure of an integrity check of the TAU request message in an MME. In receiving the registration accept message, processor 212 may receive the registration accept message responsive to the failure of the integrity check of the TAU request message in the MME but success of an integrity check of the registration request message in an AMF.

### Illustrative Processes

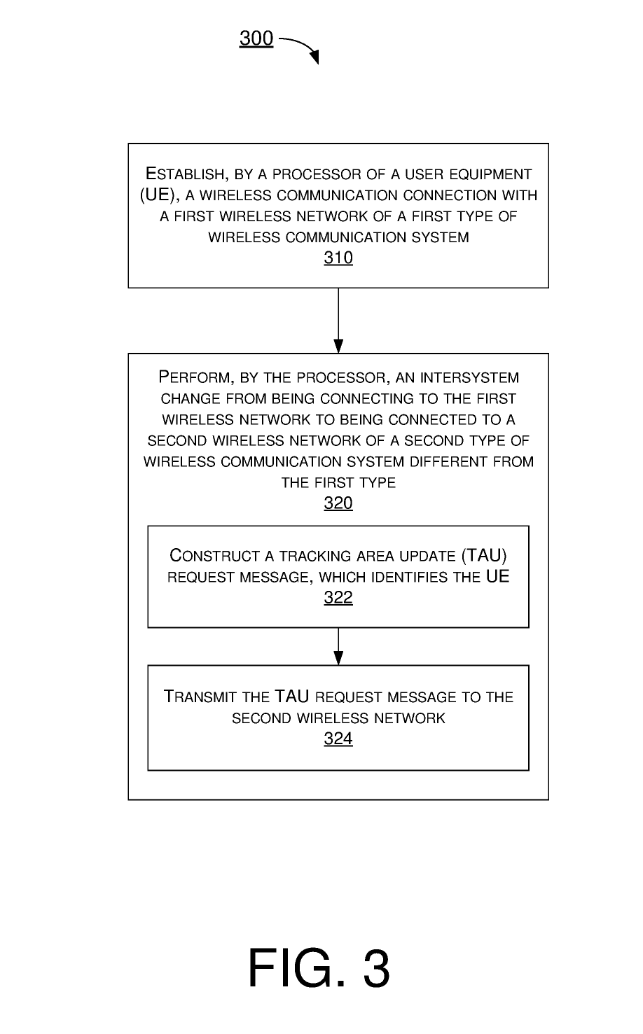

FIG. 3 illustrates an example process 300 in accordance with an implementation of the present disclosure. Process 300 may represent an aspect of implementing various proposed designs, concepts, schemes, systems and methods described above, whether partially or entirely, including scenario 30. More specifically, process 300 may represent an aspect of the proposed concepts and schemes pertaining to an improved TAU procedure for intersystem change in mobile communications. Process 300 may include one or more operations, actions, or functions as illustrated by one or more of blocks 310 and 320 as well as sub-blocks 322 and 324. Although illustrated as discrete blocks, various blocks of process 300 may be divided into additional blocks, combined into fewer blocks, or eliminated, depending on the desired implementation. Moreover, the blocks/sub-blocks of process 300 may be executed in the order shown in FIG. 3 or, alternatively in a different order. The blocks/sub-blocks of process 300 may be executed iteratively. Process 300 may be implemented by or in apparatus 210 and apparatus 220 as well as any variations thereof. Solely for illustrative purposes and without limiting the scope, process 300 is described below in the context of apparatus 210 as a UE (e.g., UE 110) and apparatus 220 as a network node or base station (e.g., network node 135) of a wireless network (e.g., 5GS network 130). Process 300 may begin at block 310.

At 310, process 300 may involve processor 212 of apparatus 210 establishing, via transceiver 216, a wireless communication connection with a first wireless network of a first type of wireless communication system. Process 300 may proceed from 310 to 320.

At 320, process 300 may involve processor 212 performing, via transceiver 216, an intersystem change from being connecting to the first wireless network to being connected to a network node (e.g., apparatus 220) of a second wireless network of a second type of wireless communication system different from the first type.

In performing the intersystem change, process 300 may involve processor 212 performing a number of operations as represented by sub-blocks 322 and 324.

At 322, process 300 may involve processor 212 constructing a TAU request message, with the TAU request message identifying apparatus 210. Process 300 may proceed from 322 to 324.

At 324, process 300 may involve processor 212 transmitting, via transceiver 216, the TAU request message to the second wireless network.

In some implementations, the first type of wireless communication system may include an EPS communication system, and the second type of wireless communication system may include a 5GS communication system.

In some implementations, the TAU request message may include a plurality of information elements such as, for example and without limitation, a protocol discriminator, a security header type, a TAU request message identity, an EPS update type, a NAS key set identifier, and an old GUTI.

In some implementations, in constructing the TAU request message, process 300 may involve processor 212 encoding the TAU request message using an EMM protocol.

In some implementations, in encoding the TAU request message using the EMM protocol, process 300 may involve processor 212 encoding the TAU request message containing an EPS update type indicating TAU for intersystem change from S1 mode to N1 mode.

In some implementations, in encoding the TAU request message using the EMM, process 300 may involve processor 212 encoding the TAU request message using an EMM protocol while in an EMM-registered state. Additionally, process 300 may involve processor 212 considering that a tracking area updating procedure is not initiated and remaining in the EMM-registered state after transmitting the TAU request message to the second wireless network.

In some implementations, in performing the intersystem change, process 300 may further involve processor 212 performing additional operations. For instance, process 300 may involve processor 212 transmitting, via transceiver 216, a registration request message to the second wireless network. Moreover, process 300 may involve processor 212 incrementing an uplink NAS count associated with an EPS security context by 1.

In some implementations, in performing the intersystem change, process 300 may further involve processor 212 receiving, via transceiver 216, a registration reject message that requests the UE to re-register in the second type of wireless communication system and to perform a specific procedure. In receiving the registration reject message, process 300 may involve processor 212 receiving the registration reject message responsive to failure of an integrity check of the TAU request message in a Mobility Management Entity (MME). In some implementations, the registration reject message may contain a cause value indicating that an identity of the UE cannot be derived, and the specific procedure may involve entering into at least one of an EMM-deregistered state and a 5GMM-deregistered state.

Alternatively, in performing the intersystem change, process 300 may further involve processor 212 receiving, via transceiver 216, a deregistration request message that requests the UE to re-register in the second type of wireless communication system. In receiving the deregistration request message, process 300 may involve processor 212 receiving the deregistration request message responsive to failure of an integrity check of the TAU request message in an MME.

Alternatively, in performing the intersystem change, process 300 may further involve processor 212 receiving, via transceiver 216, a registration accept message with an indication of failure of an integrity check of the TAU request message in an MME. In receiving the registration accept message, process 300 may involve processor 212 receiving the registration accept message responsive to the failure of the integrity check of the TAU request message in the MME but success of an integrity check of the registration request message in an AMF.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
establishing, by a processor of a user equipment (UE), a wireless communication connection with a first wireless network of a first type of wireless communication system; and
performing, by the processor, an intersystem change from being connecting to the first wireless network to being connected to a second wireless network of a second type of wireless communication system different from the first type,
wherein the performing of the intersystem change comprises:
constructing a tracking area update (TAU) request message; and
transmitting the TAU request message to the second wireless network, and
wherein the TAU request message identifies the UE.

2. The method of claim 1, wherein the first type of wireless communication system comprises an Evolved Packet System (EPS) communication system, and wherein the second type of wireless communication system comprises a 5^{th}-Generation System (5GS) communication system.

3. The method of claim 1, wherein the TAU request message comprises a plurality of information elements comprising:
a protocol discriminator;
a security header type;
a TAU request message identity;
an Evolved Packet System (EPS) update type;
a non-access stratum (NAS) key set identifier; and
an old globally unique temporary identifier (GUTI).

4. The method of claim 1, wherein the constructing of the TAU request message comprises encoding the TAU request message using an Evolved Packet System (EPS) Mobility Management (EMM) protocol.

5. The method of claim 4, wherein the encoding of the TAU request message using the EMM protocol comprises:
encoding the TAU request message containing an EPS update type indicating TAU for intersystem change from S1 mode to N1 mode.

6. The method of claim 4, wherein the encoding of the TAU request message using the EMM protocol comprises:
encoding the TAU request message using an EMM protocol while in an EMM-registered state; and
considering that a tracking area updating procedure is not initiated and remaining in the EMM-registered state after transmitting the TAU request message to the second wireless network.

7. The method of claim 1, wherein the performing of the intersystem change further comprises:
transmitting, by the processor, a registration request message to the second wireless network; and
incrementing, by the processor, an uplink non-access stratum (NAS) count associated with an Evolved Packet System (EPS) security context by 1.

8. The method of claim 7, wherein the performing of the intersystem change further comprises:
receiving, by the processor, a registration reject message that requests the UE to re-register in the second type of wireless communication system and to perform a specific procedure,
wherein the receiving of the registration reject message comprises receiving the registration reject message responsive to failure of an integrity check of the TAU request message in a Mobility Management Entity (MME).

9. The method of claim 8, wherein the registration reject message contains a cause value indicating that an identity of the UE cannot be derived, and wherein the specific procedure comprises entering into at least one of an Evolved Packet System (EPS) Mobility Management (EMM)-deregistered state and a 5^{th}-Generation Mobility Management (5GMM)-deregistered state.

10. The method of claim 7, wherein the performing of the intersystem change further comprises:
receiving, by the processor, a deregistration request message that requests the UE to re-register in the second type of wireless communication system,
wherein the receiving of the deregistration request message comprises receiving the deregistration request message responsive to failure of an integrity check of the TAU request message in a Mobility Management Entity (MME).

11. The method of claim 7, wherein the performing of the intersystem change further comprises:
receiving, by the processor, a registration accept message with an indication of failure of an integrity check of the TAU request message in a Mobility Management Entity (MME),
wherein the receiving of the registration accept message comprises receiving the registration accept message responsive to the failure of the integrity check of the TAU request message in the MME but success of an integrity check of the registration request message in an access and mobility management function (AMF).

12. An apparatus implementable in a user equipment (UE), comprising:
a transceiver capable of wireless communications; and
a processor coupled to the transceiver, the processor capable of:
establishing, via the transceiver, a wireless communication connection with a first wireless network of a first type of wireless communication system; and
performing, via the transceiver, an intersystem change from being connecting to the first wireless network to being connected to a second wireless network of a second type of wireless communication system different from the first type,
wherein, in performing the intersystem change, the processor is capable of performing operations comprising:
constructing a tracking area update (TAU) request message; and
transmitting, via the transceiver, the TAU request message to the second wireless network, and
wherein the TAU request message identifies the UE.

13. The apparatus of claim 12, wherein the first type of wireless communication system comprises an Evolved Packet System (EPS) communication system, wherein the second type of wireless communication system comprises a 5^{th}-Generation System (5GS) communication system, and wherein the TAU request message comprises a plurality of information elements comprising:
a protocol discriminator;
a security header type;
a TAU request message identity;
an Evolved Packet System (EPS) update type;
a non-access stratum (NAS) key set identifier; and
an old globally unique temporary identifier (GUTI).

14. The apparatus of claim 12, wherein, in constructing the TAU request message, the processor is capable of encoding the TAU request message using an Evolved Packet System (EPS) Mobility Management (EMM) protocol.

15. The method of claim 14, wherein the encoding of the TAU request message using the EMM protocol comprises:
encoding the TAU request message containing an EPS update type indicating TAU for intersystem change from S1 mode to N1 mode.

16. The apparatus of claim 14, wherein, in encoding the TAU request message using the EMM protocol, the processor is capable of:
encoding the TAU request message using an EMM protocol while in an EMM-registered state; and
considering that a tracking area updating procedure is not initiated and remaining in the EMM-registered state after transmitting the TAU request message to the second wireless network.

17. The apparatus of claim 12, wherein, in performing the intersystem change, the processor is further capable of:
transmitting, via the transceiver, a registration request message to the second wireless network; and
incrementing an uplink non-access stratum (NAS) count associated with an Evolved Packet System (EPS) security context by 1.

18. The apparatus of claim 17, wherein, in performing the intersystem change, the processor is further capable of:
receiving, via the transceiver, a registration reject message that requests the UE to re-register in the second type of wireless communication system and to perform a specific procedure,
wherein the receiving of the registration reject message comprises receiving the registration reject message responsive to failure of an integrity check of the TAU request message in a Mobility Management Entity (MME),
wherein the registration reject message contains a cause value indicating that an identity of the UE cannot be derived, and
wherein the specific procedure comprises entering into at least one of an Evolved Packet System (EPS) Mobility Management (EMM)-deregistered state and a 5^{th}-Generation Mobility Management (5GMM)-deregistered state.

19. The apparatus of claim 17, wherein, in performing the intersystem change, the processor is further capable of:
receiving, via the transceiver, a deregistration request message that requests the UE to re-register in the second type of wireless communication system,
wherein the receiving of the deregistration request message comprises receiving the deregistration request message responsive to failure of an integrity check of the TAU request message in a Mobility Management Entity (MME).

20. The apparatus of claim 17, wherein, in performing the intersystem change, the processor is further capable of:
receiving, via the transceiver, a registration accept message with an indication of failure of an integrity check of the TAU request message in a Mobility Management Entity (MME),
wherein the receiving of the registration accept message comprises receiving the registration accept message responsive to the failure of the integrity check of the TAU request message in the MME but success of an integrity check of the registration request message in an access and mobility management function (AMF).
